(19) United States
(12) Patent Application Publication
(10) Pub. No.: US 2006/0237386 A1
(43) Pub. Date: Oct. 26, 2006

(54) Stylus Lanyard for Use in a Corrosive Environment Conditions

(76) Inventor: Gregory A. Ouzonian, Castro Valley, CA (US)

Correspondence Address: FOOTHILL LAW GROUP, 777 N. FIRST STREET, SUITE325, SAN JOSE, CA, 95112, US

(21) Appl. No.: 11/379,007

(22) Filed: Apr. 17, 2006

Related U.S. Application Data
(63) Continuation-in-part of application No. 10/922,347, filed on Aug. 19, 2004.
Application No. 10/922,347 is a continuation of application No. 10/843,757, filed on May 11, 2004.
(60) Provisional application No. 60/469,272, filed on May 12, 2003.

(51) Int. Cl. B66C 23/00

(52) U.S. Cl. 212/201

(57) ABSTRACT

A stylus lanyard for use in a corrosive environment, comprising: a) a first steel open/close clasp swivel comprising a first clasp part, a first swivel and a first ring, b) a first braided steel cable, said cable having a first end and a second end and comprising a first loop at the first end, the first loop passing through the first ring, c) a first crimp sleeve on the braided steel cable, an end of the first loop passing through the first crimp sleeve, whereby the first loop is secured to the braided cable by the first crimp sleeve, and the first open/close clasp swivel is attached to the first loop, and d) an attachment means for attaching a stylus to the stylus lanyard. All of the components are preferably stainless steel.

This application is a continuation-in-part of my co-pending application Ser. No. 10/922,347 filed on Aug. 19, 2004 which is a continuation of my co-pending application Ser. No. 10/843,757 filed on May 11, 2004 which application claimed the benefit of provisional application 60/469,272 filed May 12, 2003, all of which prior applications are hereby incorporated herein by reference.

### BACKGROUND OF THE INVENTION

1. Field of the Invention

This invention relates to a lanyard for attaching a stylus to a personal digital assistant, which lanyard is suitable for severe and corrosive environmental conditions and a personal digital assistant programmed for identifying hazardous materials and response thereto with a lanyard and stylus attached.

2. Description of the Prior Art

A stylus lanyard as used herein is a device for attaching a stylus to a portable computing device, such as a personal digital assistant, such that the stylus is capable of remaining attached to the portable computing device both while the stylus is in use or in storage. The stylus may be removable from the portable computing device during non-use.

One stylus lanyard is being supplied for use with TDS Recon PDAs. It comprises a cloth band with VELCO™ connectors on one end, to attach to a Recon PDA and a ring at the other end to attach to a stylus. The cloth band is flexible and a stylus can be used with a PDA while attached via the lanyard.

### SUMMARY OF THE INVENTION

My prior application Ser. Nos. 10/922,347 and 10/843,757, disclose computing devices useful for first responders to incidents involving hazardous materials or terrorist attacks, the devices including resources and logic for some or all of the following:
1. Provide for identifying hazardous materials based on readily observable properties of the hazardous material suitable for use by responders to a hazardous materials incident.
2. Provide for providing response information needed by responders to a hazardous materials incident, such information specific to a hazardous material that was identified based on its observable properties
3. Provide for identifying a hazardous material by signs and symptoms associated with persons having exposure to the hazardous material.
4. Provide for predicting how hazardous materials will react with each other when mixed together.
5. Provide for predicting if hazardous materials identified are precursors of illegal or controlled drugs, explosive or chemical warfare agents.

A preferred embodiment of my prior applications includes a personal digital assistant (PDA) or a smart cell phone programmed to do some or preferably all of the above functions in a tightly integrated package. Often the PDAs are used that have rugged construction and are resistant to chemicals. Such devices require a stylus to make selections. Without the stylus the PDA is of limited utility for its intended purpose, yet the stylus is easily lost in the excitement of a hazardous materials related incident. It was found through field experience that misplacing the stylus was a significant problem, and the stylus is preferably tethered to the PDA to prevent loss. It is preferable that the tether be resistant to a corrosive environment since that is the typical environment in which the programmed PDA is used. The tether must also have sufficient length and flexibility so that the PDA can be readily operated with the tethered stylus. It was found that the prior art stylus lanyard is not satisfactory for this application because the cloth band was easily subject to corrosive chemical attack. A preferred material for the stylus lanyard is stainless steel and more preferably nylon coated stainless steel and most preferably nylon coated braided stainless steel cable. However, a stylus attached to nylon coated braided stainless steel cable and attached to a PDA with a simple ring, such as a key ring, proved to be too stiff and tended to bind and become tangled so as to make it difficult to operate the PDA with the stylus. It was found that attaching a first end of the braided stainless steel cable to a stainless steel clasp swivel, such as are commonly used by fisherman for attaching a lure to a fishing line, and attaching the swivel to the PDA was far more preferable than attaching the braided stainless steel cable directly to the PDA or with a ring. The clasp part of the clasp swivel is attached to a surface on the PDA and swivel is attached to a loop at a first end of the braided steel cable. The second end of the braided stainless steel cable is attached to the stylus by an attachment means. The nature of the attachment means depends on the stylus type which varies with different manufacturers. Several different attachment means are as follows:
1. A threaded stainless steel eye ring machine screw threaded into the opening where a threaded end cap was screwed on an end of the original stylus. The eye ring is attached to the braided stainless steel rope by a second clasp swivel.
2. The clasp on a second clasp swivel is placed though an eyelet punched through the end of a stylus having such an eyelet at one end,
3. A threaded cap with male threads screwed into female threads on a hollow stylus. The threaded cap has a hole therein through which the second end of the braided steel rope is placed, said rope having a ball crimped to the second end which will not fit through the hole in the threaded cap when the cap is screwed into the stylus.

It was found that a stylus attached to a lanyard according to the invention operated the PDA comfortably without binding and tangling and without damage by chemical and organic agents.

### BRIEF DESCRIPTION OF THE DRAWINGS

FIG. 1 is a diagram of a stylus lanyard having a first attachment means.

FIG. 2 is a diagram of a stylus lanyard having a second attachment means.

FIG. 3 is a diagram of a stylus lanyard having a third attachment means.

FIG. 4 is a diagram of a stylus lanyard attached to a PDA.

These and other features, aspects and advantages of the present invention will become better understood with regard to the following description, appended claims and accompanying drawings.

### DESCRIPTION

One embodiment of present invention is a new stylus lanyard for attaching a stylus to a personal digital assistant (PDA), suitable for use in a chemically corrosive environment and suitable to readily use the stylus while attached to the PDA.

The stylus lanyard comprises:
a. an open/close clasp swivel, whereby the clasp of the clasp swivel may be attached to a PDA,
b. a braided steel cable, wherein said cable comprises a loop formed in a first end thereof with the first end of said cable passing through an opening on an end of the clasp swivel,
c. a crimp sleeve, threaded onto the cable securing the loop formed in the first end of the cable, and
d. an attachment means for attaching the lanyard to a stylus.

The lanyard may further comprise a stylus attached to the attachment means, and the lanyard may be attached to a PDA.

The steel clasp swivel is preferably stainless steel and the braided steel cable is preferably nylon coated stainless steel. The preferred outer diameter of the cable is about 3/64 inch.

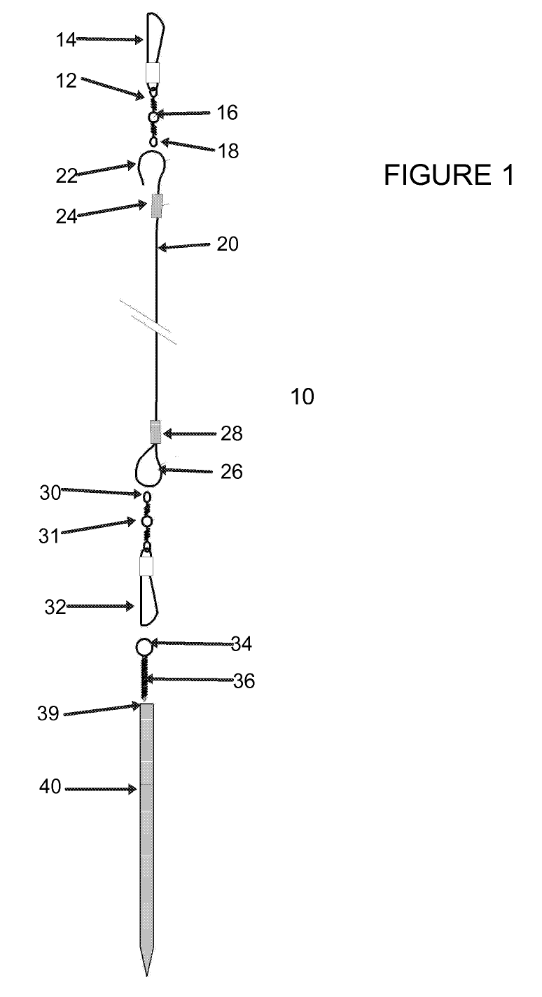

Referring to FIG. 1, a stylus lanyard 10 is shown for attaching one common type of stylus in which the stylus is supplied with a threaded end cap. The stylus lanyard comprises a stainless steel clasp swivel 12, the clasp swivel comprising a clasp part 14, a swivel 16, and a ring 18. The lanyard further comprises a braided steel cable 20, which is preferably nylon coated stainless steel, a loop 22 at a first end of the cable, which loop attaches the cable to the ring 18 on the stainless steel clasp swivel, and is secured onto the cable with first crimp sleeve 24. An attachment means for attaching a stylus comprises a second loop 26 at a second end of the braided cable, the second loop being secured onto the cable with second crimp sleeve 28. The loop goes through a ring 30 in a second stainless steel clamp swivel 31. The clasp part 32 of the second clamp swivel secures to an eye in a threaded stainless steel eye-ring 34 machine screw. The threads 36 on the machine screw are screwed into the threaded end 38 of the stylus 40 from which the threaded end cap has been removed. The cable can have various dimensions, 3/64 inch diameter cable with a length of about 12 to about 18 inches is preferred.

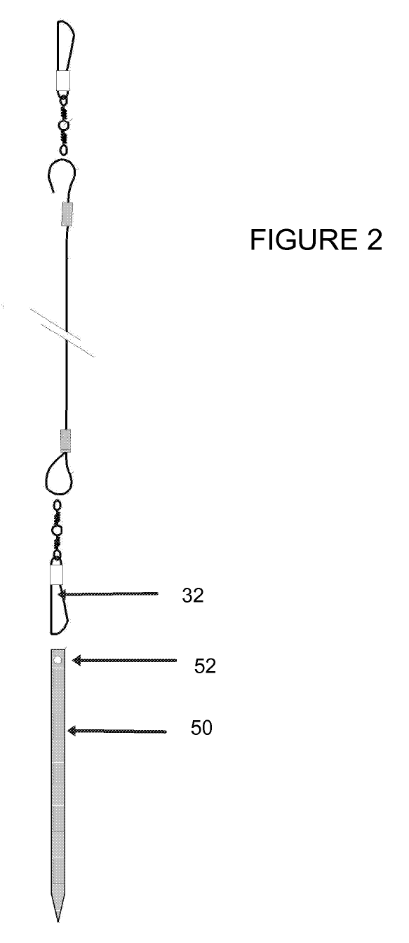

FIG. 2 shows a stylus lanyard for a type of stylus having an eyelet 52 at one end of the stylus 50. This case is identical to FIG. 1, except the machine screw is not used, but rather the clasp part 32 of the clasp swivel is attached through the eyelet 52.

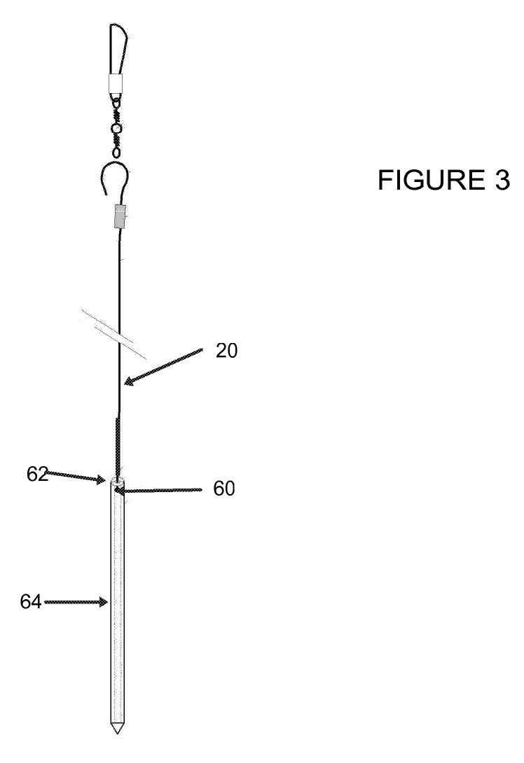

FIG. 3 shows a stylus lanyard for another type of stylus which is a threaded hollow stylus or a stylus with a threaded hollow core. In this case the second end of the cable terminates in a crimped on ball 60. A threaded cap 62 is screwed into the hollow threaded stylus 64. In this case there is a hole in the threaded cap, such that the cable 20 fits through the hole in the threaded cap but the ball has a larger diameter than the hole, such that when the cap is screwed into the stylus, the ball is retained.

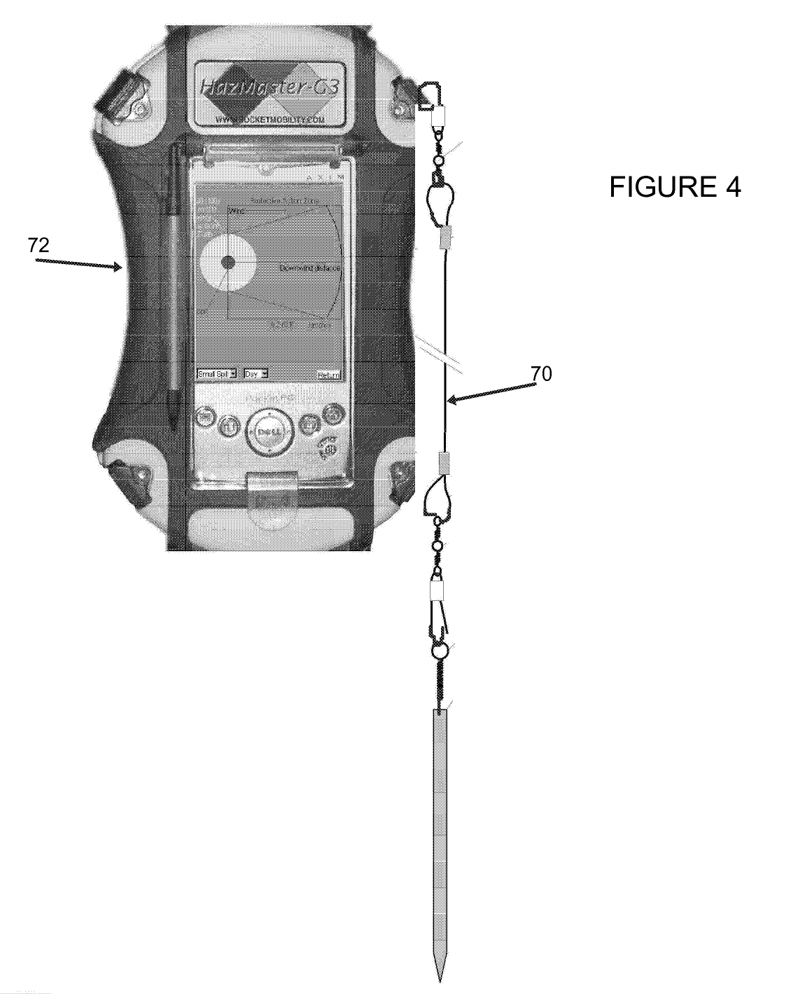

FIG. 4 shows a stylus lanyard and stylus 70 attached to a PDA 72. The PDA has logic and resources to be used by a first responder at a hazardous incident.

Although the present invention has been described in considerable detail with reference to certain preferred versions thereof, other versions are possible. Therefore the spirit and scope of the appended claims should not be limited to the preferred versions herein.

I claim:

1. A stylus lanyard for use in a corrosive environment, comprising:
a) a first steel open/close clasp swivel comprising a first clasp part, a first swivel and a first ring,
b) a first braided steel cable, said cable having a first end and a second end and comprising a first loop at the first end, the first loop passing through the first ring,
c) a first crimp sleeve on the braided steel cable, an end of the first loop passing through the first crimp sleeve, whereby the first loop is secured to the braided cable by the first crimp sleeve, and the first open/close clasp swivel is attached to the first loop, and
d) an attachment means for attaching a stylus to the stylus lanyard.

2. The stylus lanyard of claim 1, wherein the attachment means comprises:
a) a second loop at the second end of the braided cable,
b) a second steel crimp sleeve on the braided cable,
c) a second steel open/close clasp swivel comprising a second clasp part, a second swivel, and a second ring,
d) a threaded steel eye-ring machine screw, comprising an eye and a threaded part the threaded part is adapted to screw into a stylus having a threaded end cap, when the end cap is removed, and
e) wherein the second loop passes through the second ring and the second crimp sleeve, whereby the second loop is secured to the second end of the braided cable and the second open/close clamp swivel is attached to the second loop, and wherein the second clasp part is attached to the eye, whereby the stylus lanyard may be attached to the stylus by removing the threaded end cap and screwing in the thread part of the eye-ring machine screw.

3. The stylus lanyard of claim 2, wherein the first braided steel cable, the first steel open/close clasp swivel, the first steel crimp sleeve, the threaded steel eye ring, the second steel open/close clasp swivel, and the second steel crimp sleeve are all made of stainless steel.

4. The stylus lanyard of claim 3, wherein the braided cable is made of nylon coated stainless steel.

5. The stylus lanyard of claim 4 attached to the stylus.

6. The stylus lanyard of claim 1, wherein the attachment means comprises:
a. a second loop at the second end of the braided cable,
b. a second steel crimp sleeve on the braided cable,
c. a second steel open/close clasp swivel comprising a second clasp part, a second swivel, and a second ring, and
d. wherein the second loop passes through the second ring and the second crimp sleeve, whereby the second loop is secured to the second end of the braided cable and the second open/close clamp swivel is attached to the second loop, and wherein the second clasp part may be attached to the eyelet opening in one end of a stylus.

7. The stylus lanyard of claim 6 attached to a stylus.

8. The stylus lanyard of claim 7, wherein the first braided steel cable, the first steel open/close clasp swivel, the first steel crimp sleeve, the second steel open/close clasp swivel, and the second steel crimp sleeve are all made of stainless steel.

9. The stylus lanyard of claim 8, wherein the braided cable is made of nylon coated stainless steel.

10. The stylus lanyard of claim 1, wherein the attachment means comprises:
a. a ball crimped on to the second end of the braided steel cable, and
b. a threaded cap adapted to screw into a hollow metal stylus comprising inner threads, wherein said threaded cap defines a hole in an end thereof, the hole being of lesser diameter than the ball but greater diameter than the braided cable, whereby when the cable runs through the hole and the end cap is screwed into the inner threads of the hollow stylus, the stylus will be secured to the stylus lanyard.

11. The stylus lanyard of claim 10 attached to a stylus.

12. The stylus lanyard of claim 9, wherein the ball, the braided steel cable, the first crimp sleeve, the first steel open/close clamp clasp are made of stainless steel.

13. The stylus lanyard of claim 10, wherein the braided steel cable is nylon coated.

14. The stylus lanyard and the stylus of claim 5 attached to a Personal Digital Assistant.

15. The stylus lanyard and the stylus of claim 7 attached to a Personal Digital Assistant.

16. The stylus lanyard and the stylus of claim 11 attached to a personal digital assistant.
